(19) United States
(12) Patent Application Publication
(10) Pub. No.: US 2001/0021073 A1
(43) Pub. Date: Sep. 13, 2001

(54) LIGHT FILTER FOR DENTAL USE

(76) Inventors: RAYMOND ABRAHAM LEGGO, NORTH BALWYN (AU); PETER JOHN CUNNINGHAM, SOUTH YARRA (AU)

Correspondence Address: BAKER & BOTTS, 30 ROCKEFELLER PLAZA, NEW YORK, NY, 10112

(21) Appl. No.: 09/242,980

(22) PCT Filed: Sep. 3, 1997
(86) PCT No.: PCT/AU97/00569

§ 371 Date: None

(30) Foreign Application Priority Data
Sep. 3, 1996 (AU) P02056

(51) Int. Cl. G02B 5/22

(52) U.S. Cl. 359/885

(57) ABSTRACT

A light filter for dental use having: a transparent planar member (20) coloured so as to filter-out visible radiation in the range of 400 nm to 520 nm, the range being that to which dental light-cured materials are sensitive; a base (22) of a magnetic material attached to the underside of the planar member (20); and an attachment device (36) having a shell (34) of a magnetic material containing a permanent magnet (30), the attachment device (36) being attached to the lens (16).

### RELATED PATENT

This invention is related to our earlier U.S. Pat. No. 5,509,800 issued April 1996, the contents of which are herein incorporated by reference.

### FIELD OF THE INVENTION

Present invention relates to a light filter for dental use and refers particularly, though not exclusively, to a light filter for dental use which is releasably attachable to a dental lamp to enable light of a particular frequency to be filtered out.

### BACKGROUND OF THE INVENTION

In our aforesaid US Patent specification we describe and define a light filter for dental use. It has been found that a similar filter can be more easily attached to the dental lamp. It has also been found that by the new form of attachment, it is possible to provide improved filtration of the light emanating from the lamp.

### SUMMARY OF THE INVENTION

The present invention provides a light filter for dental use including a transparent planar member coloured so as to filter-out visible radiation in the range of 400 nm to 520 nm the range being that to which dental light-cured materials are sensitive; and an attachment device configured to enable the transparent planar member to be directly attached to a dental lamp immediately adjacent a lens of the dental lamp.

Preferably, the transparent planar member has attached to the underside thereof a base. Advantageously, the base is of a magnetic material such as, for example, iron, steel or ferrite.

Preferably, the attachment device is a permanent magnet attached to the dental lamp immediately in front of the lens. More preferably, the permanent magnet is a solid or hollow cylinder. More advantageously, the permanent magnet is enclosed in a shell, the shell being attached to the dental lamp. More preferably, the shell is made of a magnetic material such as, for example, iron, steel or ferrite.

Advantageously, the base is of a similar surface shape and size as the permanent magnet. More advantageously, the base is annular.

The light filter is preferably of a size and shape to enable it to completely cover the lens of the dental lamp, the light filter preferably being made so that it is disposable.

### DESCRIPTION OF THE DRAWINGS

In order that the invention may be fully understood and readily put into practical effect, there shall now be described a preferred construction of a light filter for dental use incorporating the principal features of the present invention, the description being with reference to the accompanying illustrative drawings in which:

FIG. 1 is a front perspective view showing the light filter attached to a dental lamp;

FIG. 2 is an exploded perspective view corresponding to FIG. 1;

FIG. 3 is a front view corresponding to FIG. 1; and

FIG. 4 is a partial cross-sectional view along the lines and in the direction of arrows 4-4 on FIG. 3.

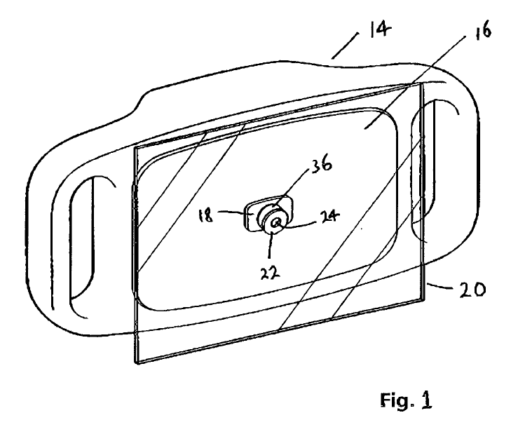

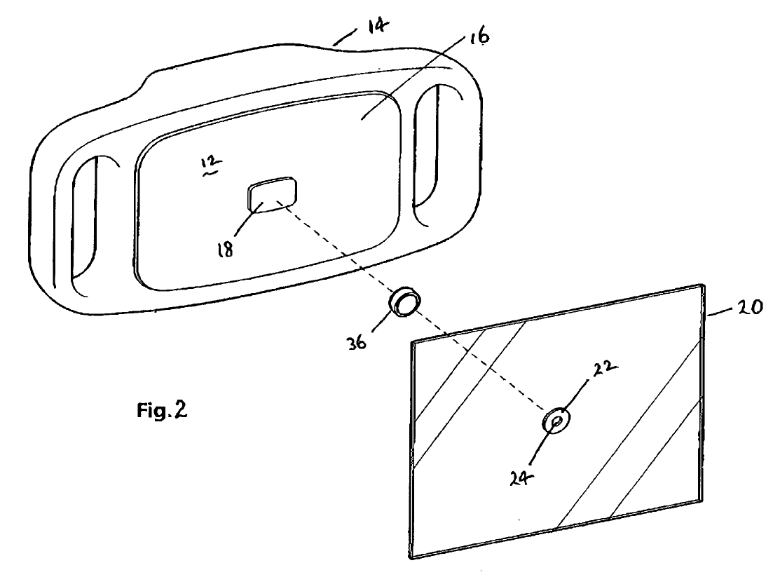

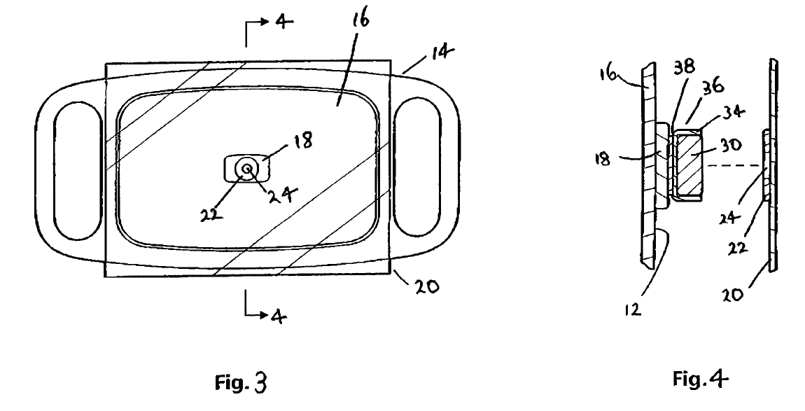

### DESCRIPTION OF THE PREFERRED EMBODIMENT

In the drawings there is shown a dental lamp 14 which is attached to a mounting bracket (not shown) which is in turn mounted to a pivotal arm (not shown). This is standard form of dental lamp, and is well known in the dental industry and profession.

Dental lamp 14 has a lens 16 at its front. In the centre of front surface 12 of lens 16 is a centre piece 18, which is intended to block a direct view of the illuminating globe (not shown), and/or to indicate the manufacturer of the lamp 14.

Adapted to be mounted on lamp 14 over lens 16 is a light filter 20, which has a central mounting base 22. The light filter 20 is in accordance with the light filter of the aforesaid U.S. Pat. No. 5,509,800 and thus further description of that filter will not be made here. However, by virtue of the placement of the filter 20 directly in front of the lens 16 of the lamp 14, the filter 20 may be made of a slightly thicker material to allow for the heat generated by the lamp. Alternatively, it may be made relatively thin so that it is disposable.

The filter 20 is sized and shaped to fit over the lens 16 and is preferably substantially the same size as or slightly larger than lens 16. Preferably, it is not smaller. In this way, effectively all of the light emanating from lamp 14 through lens 16 is filtered by the filter 20. Although the filter 20 is shown as being rectangular, it may be any shape required such as, for example, circular, pentagonal, hexagonal, ovular, elliptical, octagonal, or otherwise.

Base 22 is secured to the under surface of lens 20. Base 22 is preferably made of a magnetic material such as iron, steel or ferrite. It may be of any appropriate size or shape although, as illustrated, it is in the form of an annular disc, having a central opening 24.

Mountable to centre piece 18 is the attachment device generally designated 36. In a preferred form, the attachment device 36 includes a shell 34 which is approximately cup shaped. Mounted within shell 34 is a permanent magnet 30 which may be in the form of solid cylinder, as shown, or a hollow cylinder. The magnet 30 will, upon assembly, be substantially co-axial with base 22 and opening 24. If the centre piece 18 is of a magnetic material, by having permanent magnet 30 within a shell 34 of a magnetic material, the attachment device 36 will be able to be attached to the centre piece 18 by virtue of its own magnetism. If centre piece 18 is not of a magnetic material, as an alternative shell 34 may be attached to centre piece 18 or front surface 12 of lens 16 by gluing, screwing, double-sided adhesive tape 38, or any other suitable method or means known.

In use, the attachment device 36 is attached to the centre piece 18. The filter 20 can then be placed over lens 16 such that base 22 contacts and is attached to magnet 30. This provides for minimal spacing between filter 20 and lens 16, and also provides for secure attachment of the filter 20 to the lamp 14. By using a permanent magnet 30, and an annular disc for the base 22, a continuous path for magnetic flux is formed. This minimises the loss of magnetic flux to the atmosphere to thus enhance the magnetic attraction.

Base 22 is attached to filter 20 by any suitable means such as, for example, gluing, sonic welding, screwing, or any other suitable ways. If desired, a name-plate (not shown) may be placed on the upper surface of filter 20 above base 22.

Base 22 may be made as a permanent magnet so the ‘north’ pole of base 22 aligns with ‘south’ pole of attachment device 36, to thus provide secure yet releasable attachment. This would enable base 22 to be attached directly to centre piece 18 if desired. Furthermore, the base 22 may be of any suitable size or shape, as may be the attachment device 36. Although circular as shown, square, rectangular, or any other suitable shape may be used, including bar shaped.

Attachment device 36 may be attached to centre piece 18 in a permanent or semi-permanent manner, and the filter 20 replaced as required. In this way the filter 20 may be made disposable, yet the attachment device 36 may be reusable.

Dental lamps are generally made as being somewhat elliptical or rectangular, and are normally oriented either somewhat horizontally or vertically. By having the filter 20 made as a general rectangular shape, it will be suitable for either form of dental lamp. The rectangular shape will cover the entirety of the lens 16 to minimise the likelihood of light impacting upon the light-cured dental material in use to thus delay the curing of that material, and thus prolong the time available to the dentist or dental surgeon in using that material.

Whilst there has been described in the foregoing description a preferred construction of a light filter for dental use, it will be understood by those skilled in the technology concerned that many variations or modifications in details of design or construction may be made without departing from the essential features of the present invention.

It will be understood that the invention disclosed and defined herein extends to all alternative combinations of two or more of the individual features mentioned or evident from the text or drawings. All of these different combinations constitute various alternative aspects of the invention.

It will also be understood that where the term “comprises” or its grammatical variants, is employed herein, it is equivalent to the term “includes” and is not to be taken as excluding the presence of other elements or features.

1. A light filter for dental use including a transparent planar member coloured so as to filter-out visible radiation in the range of 400 nm to 520 nm, the range being that to which dental light-cured materials are sensitive; and an attachment device configured to enable the transparent planar member to be directly attached to a dental lamp immediately adjacent a lens of the dental lamp.

2. A light filter as claimed in claim 1, wherein the transparent planar member has an underside to which is attached a base made of a magnetic material.

3. A light filter as claimed in claim 2, wherein the attachment device is a permanent magnet attachable to the dental lamp immediately in front of the lens, the permanent magnet being enclosed in a shell of a magnetic material.

4. A light filter as claimed in claim 3, wherein the base has a surface shape and size substantially the same as the surface shape and size of the permanent magnet.

5. A light filter as claimed in claim 1, wherein the transparent planar member is sized and shaped to completely cover the lens.
